(19) United States
(12) Patent Application Publication
(10) Pub. No.: US 2024/0392793 A1
(43) Pub. Date: Nov. 28, 2024

(54) ROTATING MACHINE HAVING CONTRA-ROTATING PROPELLER

(71) Applicant: VAM Inc., Changwon-si (KR)

(72) Inventor: Dohyun KANG, Changwon-si (KR)

(21) Appl. No.: 18/674,946

(22) Filed: May 27, 2024

(30) Foreign Application Priority Data
May 25, 2023 (KR) 10-2023-0067451

(51) Int. Cl. F04D 19/02; F04D 25/06

(52) U.S. Cl. CPC F04D 19/024; F04D 25/0633

(57) ABSTRACT

Provided is a rotating machine which may include a fixed shaft; a fixation module having at least one fixation part coupled to an outer peripheral surface of the fixed shaft; and a rotation module rotatably supported by the fixed shaft, wherein the rotation module includes a first rotation module and a second rotation module, the first rotation module including a first rotation module support, a first rotation module-permanent magnet installed on an inner peripheral surface of the first rotation module support, and a first rotation module propeller installed on an outer peripheral surface of the first rotation module support, and the second rotation module including a second rotation module support, a second rotation module-permanent magnet installed on an inner peripheral surface of the second rotation module support, and a second rotation module propeller installed on an outer peripheral surface of the second rotation module support.

### TECHNICAL FIELD

The present disclosure relates to a rotating machine, and more particularly, to a rotating machine which may improve the efficiencies of an electric motor generating thrust by a contra-rotation of a propeller and a generator producing electricity and miniaturize the same.

### BACKGROUND ART

In recent years, electric mobility (or e-mobility) has become popular and an eco-friendly technology has emerged, and a technology for increasing the outputs and output efficiencies of an electric motor and a generator, included in a propulsion device, is thus becoming important.

The electric motor or the generator is a device that converts electrical energy into mechanical energy or the mechanical energy into the electrical energy, by using a principle of electromagnetic field. In detail, the electric motor may be a rotating machine including a permanent magnet by allowing a current to flow through a winding wound around a fixation part, and the generator may be the rotating machine including the permanent magnet to thus generate the current in the winding wound around the at least one fixation part.

The rotating machine with a propeller may rotate a fluid. The rotating machine may be propelled or generate power using a single propeller. However, in this case, cavitation may occur behind the propeller, thus significantly lowering efficiency of the motor or the generator.

The present disclosure may solve this problem by using two propellers rotating in opposite directions in the rotating machine rather than the single propeller. The contra-rotating propeller (CRP) may refer to a fluid propulsion device in which the two propellers rotating in contra-directions are disposed on the same axis, and which may improve overall efficiency of the motor or the generator by recovering rotational energy lost from a front propeller to a rear propeller. A fluid-based electric propulsion device such as a ship or a drone is premised on its movement, thus requiring high output and high efficiency, and a propeller using the contra-rotating propellers may be suitable therefor.

### RELATED ART DOCUMENT

### Patent Document

Korean Patent Laid-Open Publication No. 10-2014-0013199 (published on Feb. 5, 2014).

### DISCLOSURE

### Technical Problem

Various embodiments of the present disclosure may provide a rotating machine having a contra-rotating propeller that may improve the maximum output of the rotating machine.

Various embodiments of the present disclosure may provide a rotating machine having a contra-rotating propeller that may improve efficiency of the rotating machine.

Various embodiments of the present disclosure may provide a rotating machine having a contra-rotating propeller that may minimize a volume of the rotating machine.

Various embodiments of the present disclosure may provide a rotating machine having a contra-rotating propeller that may enable effective heat dissipation.

Various embodiments of the present disclosure may provide a rotating machine having a contra-rotating propeller that may improve durability of the rotating machine.

Various embodiments of the present disclosure may provide a rotating machine having a contra-rotating propeller that may have great versatility and improved marketability.

### Technical Solution

According to various embodiments, a rotating machine may include: a fixed shaft; a fixation module having at least one fixation part coupled to an outer peripheral surface of the fixed shaft; and a rotation module rotatably supported by the fixed shaft, wherein the rotation module includes a first rotation module including a first rotation module support having a space accommodating a portion of the at least one fixation part, a first rotation module-permanent magnet installed on an inner peripheral surface of the first rotation module support, and a first rotation module propeller installed on an outer peripheral surface of the first rotation module support, and a second rotation module including a second rotation module support having a space accommodating another portion of the at least one fixation part, a second rotation module-permanent magnet installed on an inner peripheral surface of the second rotation module support, and a second rotation module propeller installed on an outer peripheral surface of the second rotation module support, and the first rotation module and the second rotation module are disposed to be parallel to each other in an axial direction and rotate in contra-directions.

The at least one fixation part may include a fixation module-motor winding and a fixation module-motor iron core around which the fixation module-motor winding is wound, and the fixation part provided as a single unit may be disposed while having at least a portion facing the first rotation module-permanent magnet and at least another portion facing the second rotation module-permanent magnet.

The at least one fixation part may include a fixation module-motor slot around which the fixation module-motor winding is wound, and Q=3·m, P1=3·m−n, P2=3·m+n (where, m=a, n=a−2·b+2, a and b are natural numbers, and m·n>0) when Q indicates the number of fixation module-motor slots, P1 may indicate the number of first rotation module-permanent magnets, and P2 may indicate the number of second rotation module-permanent magnets.

a=4 and b=2, therefore, m=4 and n=2, and therefore, Q=12, P1=10, and P2=14.

The at least one fixation part may include a fixation module-motor winding and a fixation module-motor iron core around which the fixation module-motor winding is wound, and wherein at least two of the at least one fixation part may be disposed while including a first fixation module-motor fixation part facing the first rotation module-permanent magnet, and a second fixation module-motor fixation part facing the second rotation module-permanent magnet.

The fixation module may include a motor support having one end connected to the fixed shaft and the other end extending outward in the other direction to support the first rotation module support and the second rotation module support.

The fixation module may include a fluid duct support having one end connected to the motor support and the other end extending outward.

The fixation module may include a fluid duct fixed to the fluid duct support and guiding a fluid flowing outside the first rotation module propeller or the second rotation module propeller to the first rotation module propeller or the second rotation module propeller.

The first rotation module and the second rotation module may be spaced apart from each other.

At least one of the at least one fixation part, the first rotation module-permanent magnet, and the second rotation module-permanent magnet may be treated with a waterproof coating.

The rotating machine may further include a rotation module bearing disposed between the rotation module and the fixation module for the rotation module to be rotatable above the fixation module.

The rotation module bearing may include a first rotation module shaft bearing disposed between the fixed shaft and the first rotation module support, and a second rotation module shaft bearing disposed between the fixed shaft and the second rotation module support.

The fixation module may include a motor support having one end connected to the fixed shaft and the other end extending outward to support the first rotation module support and the second rotation module support, and the rotation module bearing may include a first motor support bearing disposed between the motor support and the first rotation module support, and a second motor support bearing disposed between the motor support and the second rotation module support.

The rotating machine may further include a cooling hole disposed in the fixation module or the rotation module, and allowing a fluid flowing outside the rotation module and a fluid flowing inside the rotation module to communicate with each other.

According to various embodiments, a rotating machine may include: a cylindrical enclosure of an inner-rotor motor (or internal rotation type-electric motor); a fixation module of the inner-rotor motor inner-rotor motor that includes at least one fixation part coupled to an inner peripheral surface of the enclosure of the inner-rotor motor; a rotation module of the inner-rotor motor that is disposed at a center of the enclosure of the inner-rotor motor and rotatably supported by the enclosure of the inner-rotor motor, wherein the rotation module of the inner-rotor motor includes a first rotation module of the inner-rotor motor that includes a rotating first rotation module shaft of the inner-rotor motor, the first rotation module of the inner-rotor motor that includes a rotating first rotation module shaft of the inner-rotor motor, a first rotation module-permanent magnet of the inner-rotor motor that is installed on a portion of an outer peripheral surface of the first rotation module shaft of the inner-rotor motor and faces a portion of the at least one fixation part, and a first rotation module propeller installed at an end of the first rotation module shaft of the inner-rotor motor, and a second rotation module of the inner-rotor motor that includes a second rotation module shaft of the inner-rotor motor that rotates while surrounding the outer peripheral surface of the first rotation module shaft of the inner-rotor motor, a second rotation module-permanent magnet of the inner-rotor motor that is installed on a portion of an outer peripheral surface of the second rotation module shaft of the inner-rotor motor and faces another portion of the at least one fixation part, and a second rotation module propeller installed at an end of the second rotation module shaft of the inner-rotor motor, the first rotation module of the inner-rotor motor and the second rotation module of the inner-rotor motor are disposed on the same axis and rotate in contra-directions to each other, and the fixation module of the inner-rotor motor includes a fluid duct support of the inner-rotor motor that has one end connected to the enclosure of the inner-rotor motor and the other end extending outward, and a fluid duct of the inner-rotor motor that is fixed to the fluid duct support of the inner-rotor motor and guides a fluid flowing outside the first rotation module propeller or the second rotation module propeller to the first rotation module propeller or the second rotation module propeller.

The at least one fixation part may include a fixation module-motor winding of the inner-rotor motor and a fixation module-motor iron core of the inner-rotor motor, around which the fixation module-motor winding of the inner-rotor motor is wound, the at least one fixation part may include a fixation module-motor slot around which the fixation module-motor winding of the inner-rotor motor is wound, and Q−3·m, P1−3·m−n, P2−3·m+n (where, m=a, n=a−2·b+2, a and b are natural numbers, and m·n>0) when Q indicates the number of fixation module-motor slots, P1 indicates the number of first rotation module-permanent magnets, and P2 indicates the number of second rotation module-permanent magnets.

a=4 and b=2, therefore, m=4 and n=2, and therefore, Q=12, P1=10, and P2=14.

At least two of the at least one fixation part may be disposed while including a first fixation module-motor fixation part of the inner-rotor motor that faces the first rotation module-permanent magnet of the inner-rotor motor, and a second fixation module-motor fixation part of the inner-rotor motor that faces the second rotation module-permanent magnet of the inner-rotor motor.

The at least one fixation part may be disposed while having at least a portion facing the first rotation module-permanent magnet of the inner-rotor motor and at least another portion facing the second rotation module-permanent magnet of the inner-rotor motor.

### Advantageous Effects

The various embodiments of the present disclosure may provide the rotating machine having a contra-rotating propeller that may improve the maximum output of the rotating machine.

The various embodiments of the present disclosure may provide the rotating machine having a contra-rotating propeller that may improve the efficiency of the rotating machine.

The various embodiments of the present disclosure may provide the rotating machine having a contra-rotating propeller that may minimize the volume of the rotating machine.

The various embodiments of the present disclosure may provide the rotating machine having a contra-rotating propeller that may enable the efficient heat dissipation.

The various embodiments of the present disclosure may provide the rotating machine having a contra-rotating propeller that may improve the durability of the rotating machine.

The various embodiments of the present disclosure may provide the rotating machine having a contra-rotating propeller that may have the great versatility and the improved marketability.

### DESCRIPTION OF DRAWINGS

FIG. 1 is a cross-sectional view showing a rotating machine including an outer rotor according to a first embodiment of the present disclosure.

FIG. 2 is a cross-sectional view taken along line A-A of FIG. 1.

FIG. 3 is a cross-sectional view taken along line B-B of FIG. 1.

FIG. 4 is a cross-sectional view taken along line C-C of FIG. 1.

FIG. 5 is a cross-sectional view showing a rotating machine including an outer rotor according to a second embodiment of the present disclosure.

FIG. 6 is a cross-sectional view showing a rotating machine including an outer rotor according to a third embodiment of the present disclosure.

FIG. 7 is a cross-sectional view showing a rotating machine including an outer rotor according to a fourth embodiment of the present disclosure.

FIG. 8 is a cross-sectional view taken along line D-D of FIG. 7.

FIG. 9 is a cross-sectional view taken along line E-E of FIG. 7.

FIG. 10 is a cross-sectional view showing a rotating machine including an inner rotor according to a fifth embodiment of the present disclosure.

FIG. 11 is a cross-sectional view showing a rotating machine including an inner rotor according to a sixth embodiment of the present disclosure.

FIG. 12 is a cross-sectional view taken along line F-F of FIG. 11.

FIG. 13 is a cross-sectional view taken along line G-G of FIG. 11.

### BEST MODE FOR INVENTION

Hereinafter, various embodiments are described in detail with reference to the accompanying drawings. The following embodiments are disclosed to sufficiently convey the spirit of the present disclosure to those skilled in the art to which the present disclosure pertains. The present disclosure is not limited to the embodiments described herein, and may also be embodied in another form. The drawings may omit illustrations of portions unrelated to the description to clarify the present disclosure, and may exaggerate a size of component to some extent in order to aid understanding of the present disclosure.

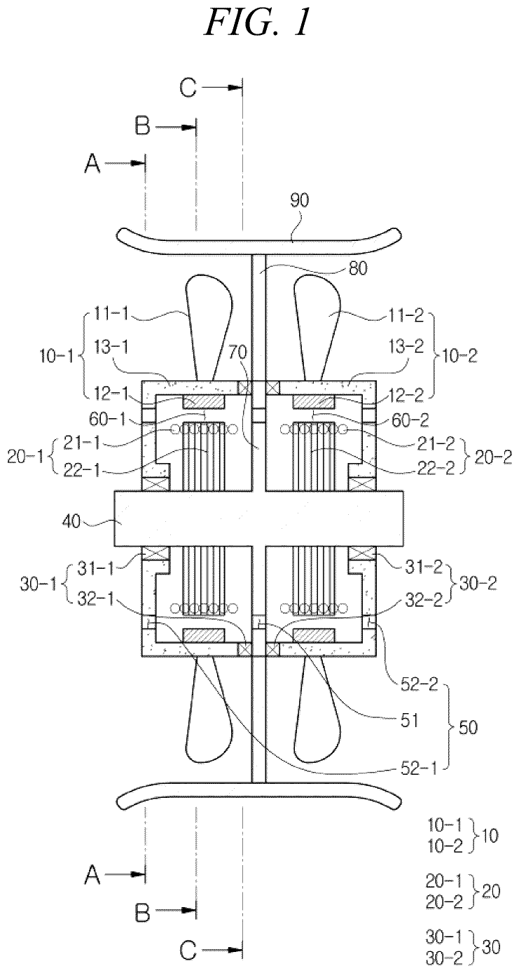

FIG. 1 is a cross-sectional view showing a rotating machine including an outer rotor according to a first embodiment of the present disclosure.

Referring to FIG. 1, the rotating machine according to the first embodiment may include a fixation module 20 including a fixed shaft 40 which is disposed on its outer peripheral surface and to which at least one fixation part is coupled to, and a rotation module 10 rotatably supported by the fixed shaft 40.

The rotation module 10 may include a first rotation module 10-1 and a second rotation module 10-2. The first rotation module 10-1 and the second rotation module 10-2 may be disposed on the fixed shaft 40 to be parallel to each other in an axial direction, and FIG. 1 shows that the first rotation module 10-1 is disposed on the left and the second rotation module 10-2 is disposed on the right.

The first rotation module 10-1 may include a first rotation module support 13-1 having a space accommodating a portion of the at least one fixation part, and the second rotation module 10-2 may include a second rotation module support 13-2 having a space accommodating another portion of the at least one fixation part.

A first rotation module propeller 11-1 may be installed on an outer peripheral surface of the first rotation module support 13-1, and a second rotation module propeller 11-2 may be installed on an outer peripheral surface of the second rotation module support 13-2. Here, the first rotation module propeller 11-1 and the second rotation module propeller 11-2 may have different blade directions, thus rotating the first rotation module 10-1 and the second rotation module 10-2 in contra-directions.

In this way, the rotating machine including a contra-rotating propeller (CRP) may improve efficiency of the rotating machine or a generator by recovering rotational energy lost from a front propeller by a rear propeller.

A first rotation module-permanent magnet 12-1 may be installed on an inner peripheral surface of the first rotation module support 13-1, and a second rotation module-permanent magnet 12-2 may be installed on an inner peripheral surface of the second rotation module support 13-2. Therefore, the first rotation module-permanent magnet 12-1 may rotate around the at least one fixation part while being spaced apart from the at least one fixation part around which the winding is wound by a first motor air gap 60-1, and the second rotation module-permanent magnet 12-2 may rotate around the at least one fixation part while being spaced apart from the at least one fixation part around which the winding is wound by a second motor air gap 60-2.

The rotating machine having the permanent magnet rotating outside the at least one fixation part may be referred to as an outer rotor (or external rotation type rotor), and conversely, the rotating machine having the permanent magnet rotating inside the at least one fixation part may be referred to as an inner rotor (or internal rotation type rotor). A torque T of the rotor may be proportional to the square of a distance r from a rotational center of the rotor to the permanent magnet, and in the rotating machine of the same volume, the outer rotor may secure the distance r greater distance than the inner rotor. Therefore, the outer rotor may have its output magnitude and efficiency greater than those of the inner rotor.

The present disclosure uses the expressions the “outer peripheral surface” and the “inner peripheral surface” such as the outer peripheral surface of the first rotation module support 13-1 and the inner peripheral surface of the first rotation module support 13-1. Referring to FIG. 1, the inner peripheral surface refers to a surface facing the fixed shaft 40, and the outer peripheral surface refers to a surface opposite to the surface facing the fixed shaft 40. The expressions the “inner peripheral surface” and the “outer peripheral surface” used below may be understood to have the same meanings as the surfaces described above.

A motor support 70 may have one end connected to the fixed shaft 40 and the other end extending outward to thus support the first rotation module support 13-1 and the second rotation module support 13-2.

The present disclosure uses the expression “outer” to refer to “the other end extending outward”. Referring to FIG. 1, the outer side (or outside) of a specific component may refer to an opposite direction from a direction in which the specific component faces the fixed shaft 40, and the inner side (or inside) of a specific component may refer to the direction in which the specific configuration faces the fixed shaft 40. The expressions “outer” and “inner” used below may be understood to have the same meaning as the directions described above.

A fluid duct support 80 may be configured to connect a fluid duct 90 to the rotation module 10. The fluid duct support 80 may have one end connected to the motor support 70 and the other end extending outward. Here, the fluid duct support 80 may be integrated with the motor support 70.

The fluid duct 90 may be fixed to the fluid duct support 80 and guide a fluid flowing outside the first rotation module propeller 11-1 or the second rotation module propeller 11-2 to the first rotation module propeller 11-1 or the second rotation module propeller 11-2. In detail, the fluid duct 90 may include a main body long in a horizontal direction to be parallel to the fixed shaft 40 and fixed to one end of the fluid duct support 80, and wings bent outward at both ends of the main body. The wing may have the end bent outward to thus more efficiently guide the fluid flowing outside the first rotation module propeller 11-1 or the second rotation module propeller 11-2 to the first rotation module propeller 11-1 or the second rotation module propeller 11-2.

The fluid duct 90 disposed outside the rotating machine may allow the fluid to flow compressively to the first rotation module propeller 11-1 or the second rotation module propeller 11-2 to thus improve the output magnitude and efficiency of the rotating machine, and protect the first rotation module propeller 11-1 or the second rotation module propeller 11-2 that protrudes outward from an external impact.

However, the fluid duct 90 in the present disclosure is not limited to its shape or connection structure according to the first embodiment, and may include any shape or connection structure disposed outside the propeller and inducing a flow of the fluid to the propeller of the rotating machine.

One or more fixation parts may be disposed on the fixed shaft 40. A case of a fixation part provided as a single unit is described in detail in a fourth embodiment described below.

In a case of the plurality of fixation parts, the at least one fixation parts may include a first fixation module-motor fixation part 20-1 facing the first rotation module-permanent magnet 12-1 and a second fixation module-motor fixation part 20-2 facing the second rotation module-permanent magnet 12-2. In detail, the first fixation module-motor fixation part 20-1 may include a first fixation module-motor winding 21-1 and a first fixation module-motor iron core 22-1, and the second fixation module-motor fixation part 20-2 may include a second fixation module-motor winding 21-2 and a second fixation module-motor iron core 22-2. The first fixation module-motor fixation part 20-1 and the second fixation module-motor fixation part 20-2 may be spaced apart from each other, and the motor support 70 may be disposed between the first fixation module-motor fixation part 20-1 and the second fixation module-motor fixation part 20-2.

A rotation module bearing 30 may be disposed between the rotation module 10 and the fixation module 20 for the rotation module 10 to be rotatable above the fixation module 20. The rotation module bearing 30 may include a first rotation module bearing 30-1 connected to the first rotation module 10-1, and a second rotation module bearing 30-2 connected to the second rotation module 10-2. The rotation module bearings 30 may respectively include rotation module shaft bearings 31-1 and 31-2 and motor support bearings 32-1 and 32-2.

The rotation module shaft bearings 31-1 and 31-2 may include the rotation module shaft bearing 31-1 disposed between the fixed shaft 40 and the first rotation module support 13-1, and the rotation module shaft bearing 31-2 disposed between the fixed shaft 40 and the second rotation module support 13-2.

The motor support bearings 32-1 and 32-2 may include the first motor support bearing 32-1 disposed between the motor support 70 and the first rotation module support 13-1, and the second motor support bearing 32-2 disposed between the motor support 70 and the second rotation module support 13-2. Therefore, the first rotation module 10-1 and the second rotation module 10-2 may rotate independently of each other while being supported by the fixed shaft 40 or the motor support 70.

Significant heat may occur in the electric motor and the generator, which utilize the at least one fixation part and the permanent magnet. Such heat occurrence may act as a factor in reducing the efficiency of the electric motor or the generator, and shortening a lifespan of a small component such as the bearing. Therefore, the rotating machine according to the first embodiment may include a cooling hole 50 for dissipating heat occurring in the first rotation module 10-1 or the second rotation module 10-2.

The cooling hole 50 may be disposed in the fixation module 20 or the rotation module 10, and allow the fluid flowing outside the rotation module 10 and the fluid flowing inside the rotation module 10 to communicate with each other. The cooling hole 50 may include a motor support-cooling hole 51, a first rotation module support-cooling hole 52-1, and a second rotation module support-cooling hole 52-2.

The first rotation module support-cooling hole 52-1 and the second rotation module support-cooling hole 52-2 may respectively be through holes for allowing the external fluid to enter the rotation module and the internal fluid to exit to the outside, based on the first rotation module 10-1 and the second rotation module 10-2. In detail, the first rotation module support-cooling hole 52-1 disposed in the first rotation module 10-1 may be disposed in front of the first rotation module support 13-1, and the second rotation module support-cooling hole 52-2 disposed in the second rotation module 10-2 may be disposed behind the second rotation module support 13-2.

The motor support-cooling hole 51 may pass through the motor support 70 to allow the fluids accommodated in the first rotation module 10-1 and the second rotation module 10-2 to communicate with each other.

One or more motor support-cooling holes 51, one or more first rotation module support-cooling holes 52-1, and one or more second rotation module support-cooling holes 52-2 may be provided.

In this way, while the rotating machine is operated, the cooling hole 50 may continuously allow the external fluid and internal fluid of the first rotation module 10-1 and the second rotation module 10-2 to communicate with each other, thereby effectively dissipating heat occurring in the rotating machine.

In preparation for a liquid fluid flowing into the first rotation module 10-1 or the second rotation module 10-2, at least one of the fixation part, the first rotation module-permanent magnet 12-1, and the second rotation module-permanent magnet 12-2 may be treated with a waterproof coating.

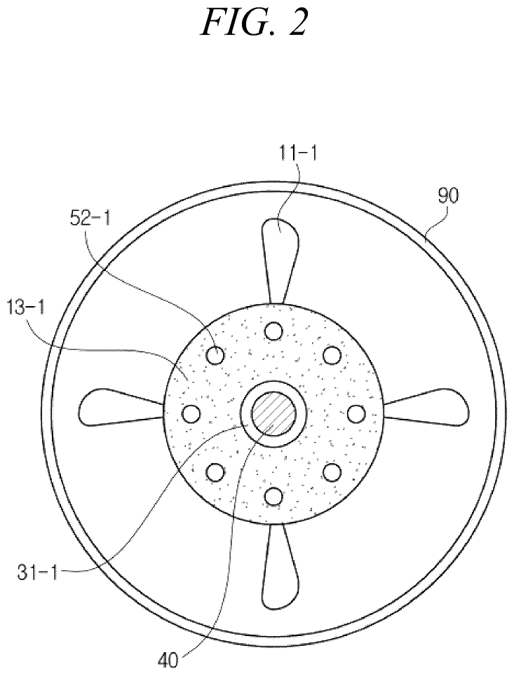

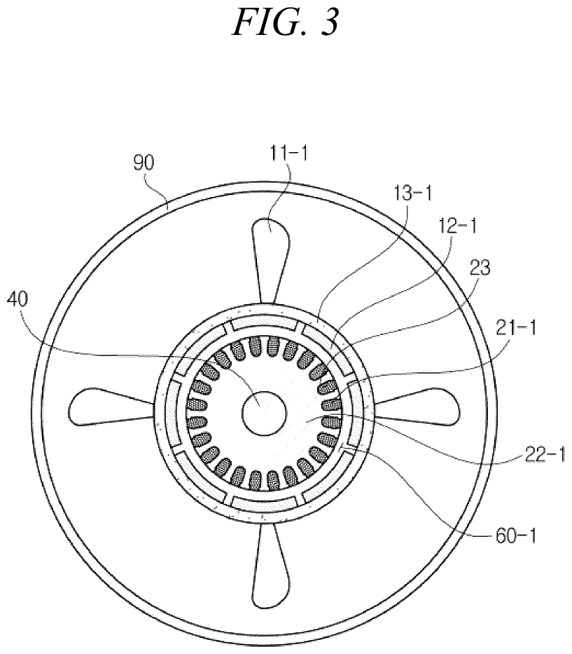

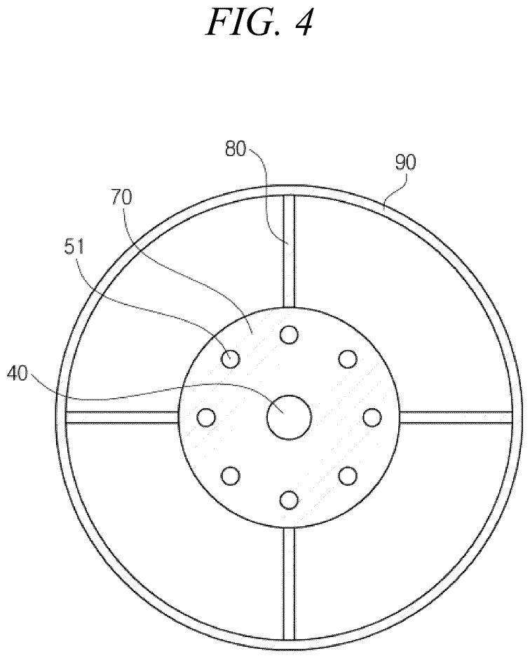

FIG. 2 is a cross-sectional view taken along line A-A of FIG. 1, FIG. 3 is a cross-sectional view taken along line B-B of FIG. 1, and FIG. 4 is a cross-sectional view taken along line C-C of FIG. 1.

Referring to FIG. 2, the fluid duct 90 may be disposed outside the rotating machine. Toward the inside of the rotating machine, the following may be sequentially disposed: the first rotation module propeller 11-1, the first rotation module support 13-1, the rotation module shaft bearing 31-1, and the fixed shaft 40. The plurality of first rotation module support-cooling holes 52-1 may be arranged in the first rotation module support 13-1. The plurality of first rotation module support-cooling holes 52-1 may be radially and symmetrically arranged based on the fixed shaft 40.

Referring to FIG. 3, the fluid duct 90 may be disposed outside the rotating machine. Toward the inside of the rotating machine, the following may be sequentially disposed: the first rotation module propeller 11-1, the first rotation module support 13-1, the first rotation module-permanent magnet 12-1 installed on the inner peripheral surface of the first rotation module support 13-1, a fixation module-motor slot 23 which is included in the at least one fixation part and around which the fixation module-motor winding 21-1 or 21-2 may be wound, and the fixed shaft 40.

Referring to FIG. 4, the fluid duct 90 may be disposed outside the rotating machine. Toward the inside of the rotating machine, the following may be sequentially disposed: the fluid duct support 80, the motor support 70, and the fixed shaft 40. The plurality of motor support-cooling holes 51 may be arranged in the motor support 70. The plurality of motor support-cooling holes 51 may be radially and symmetrically arranged based on the fixed shaft 40.

However, the first rotation module support-cooling hole 52-1 or the motor support-cooling hole 51 in the present disclosure is not limited to its shape, number, or placement structure according to the first embodiment. The cooling hole may include any shape, number, or placement structure that allows the fluid outside the rotation module 10 to communicate with the fluid inside the rotation module 10.

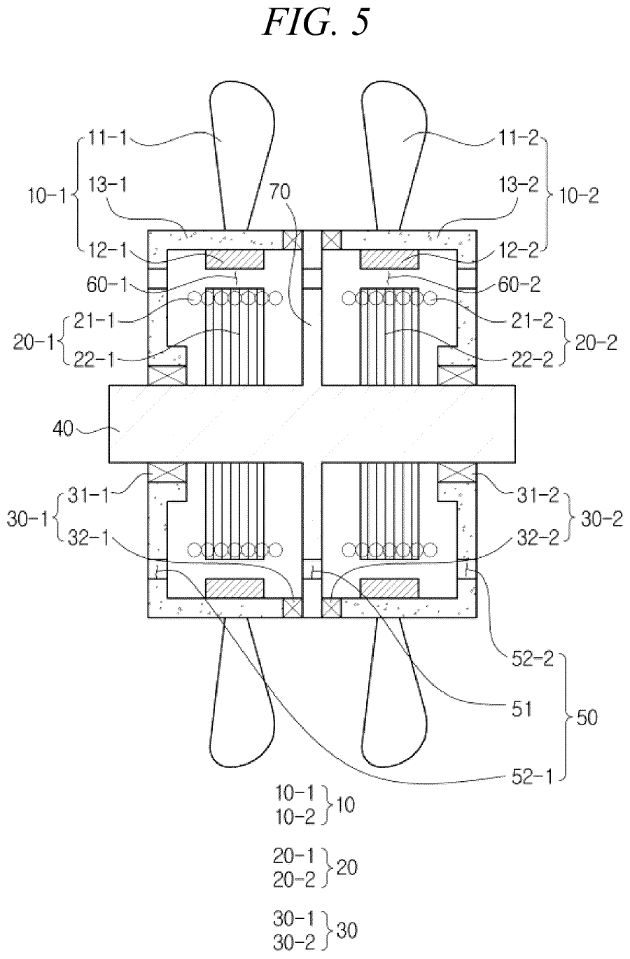

FIG. 5 is a cross-sectional view showing a rotating machine including an outer rotor according to a second embodiment of the present disclosure.

Referring to FIG. 5, the rotating machine according to the second embodiment has a difference in omitting the fluid duct 90 compared to the first embodiment. This configuration may reduce a manufacturing cost of the rotating machine by simplifying its configuration and reducing the number of parts.

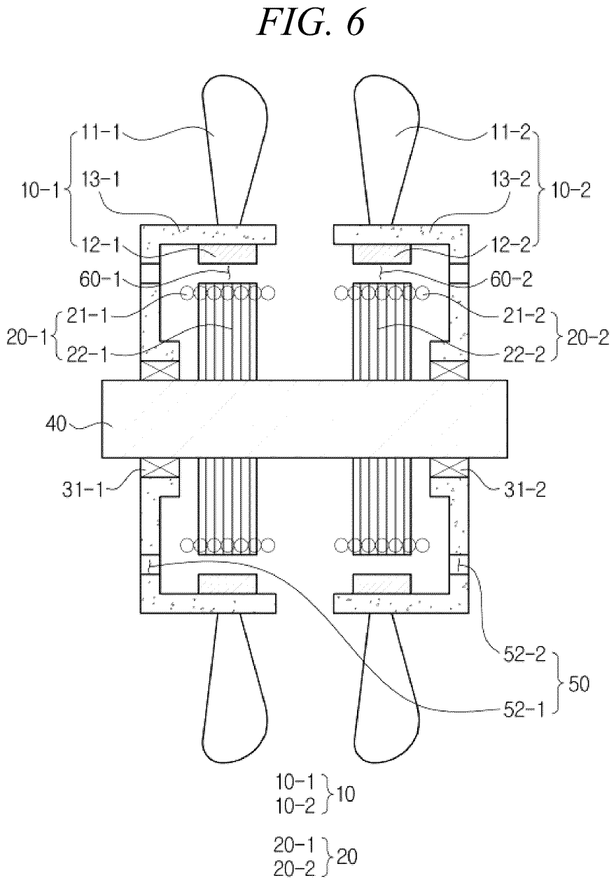

FIG. 6 is a cross-sectional view showing a rotating machine including an outer rotor according to a third embodiment of the present disclosure.

Referring to FIG. 6, the rotating machine according to the third embodiment has a difference in omitting the motor support 70 compared to the second embodiment. Here, the motor support 70 also omits the first motor support bearing 32-1 and the second motor support bearing 32-2, respectively supporting the first rotation module support 13-1 and the second rotation module support 13-2, and the first rotation module 10-1 and the second rotation module 10-2 are spaced apart from each other. This configuration may not only reduce the manufacturing cost of the rotating machine by simplifying its configuration and reducing the number of parts, but also allow a large amount of the external and internal fluids to communicate with each other between the first rotation module 10-1 and the second rotation module 10-2, thus more effectively dissipating heat occurring in the rotating machine.

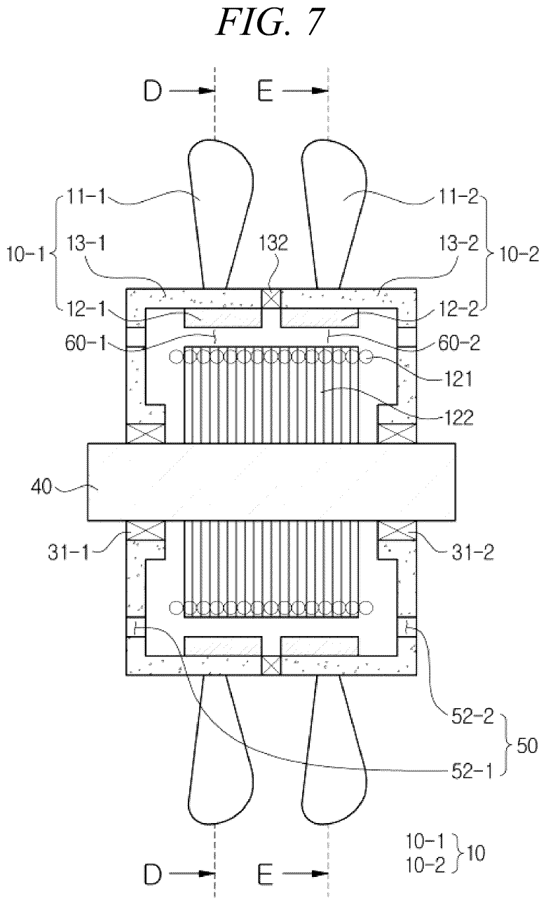

FIG. 7 is a cross-sectional view showing a rotating machine including an outer rotor according to a fourth embodiment of the present disclosure.

Referring to FIG. 7, the rotating machine according to the fourth embodiment may have differences compared to the third embodiment in disposing the single fixation part, and disposing a single fixation module-motor outer bearing 132 between the first rotation module support 13-1 and the second rotation module support 13-2.

In general, the at least one fixation part has an iron core that protrudes outward from its center and a winding that winds around an end of the iron core. Here, the winding may have an end-winding protruding from each of two sides of the iron core. That is, the at least one fixation part may have a total of four end-windings when including the first fixation module-motor fixation part 20-1 and the second fixation module-motor fixation part 20-2. Here, a portion of the iron core of the at least one fixation part or the permanent magnet may be absent in an amount as much as the amount of end-winding part, thus reducing the output and efficiency of the electric motor or the generator. Therefore, the at least one fixation part disposed in the fourth embodiment may be the single fixation part including a single fixation module-motor iron core 122 and a single fixation module-motor winding 121 surrounding the core 122, thereby reducing the number of end-windings to two end-windings, and securing larger sizes of the iron core of the at least one fixation part and the permanent magnet in the rotating machine of the same volume.

The single fixation part may be disposed while having at least a portion facing the first rotation module-permanent magnet 12-1 and at least another portion facing the second rotation module-permanent magnet 12-2.

However, the electric motor and the generator, where the two counter-rotating permanent magnets share the winding of the single fixation part (or single stator), may require a special combination of the numbers of the permanent magnets and the numbers of the fixation module-motor slots 23 in the at least one fixation part.

In detail, Q, P1, and P2 may satisfy Q−3·m, P1=3·m−n, P2=3·m+n (where, m=a, n=a−2·b+2, a and b are natural numbers, and m·n>0) when Q indicates the number of fixation module-motor slots 23 of the at least one fixation part, P1 indicates the number of first rotation module-permanent magnets 12-1, and P2 indicates the number of second rotation module-permanent magnets 12-2 in a case where the at least one fixation part includes the fixation module-motor slot 23 around which the winding is wound.

The same may be true for Q, P1, and P2 in the fourth embodiment of the present disclosure. For example, a=4 and b=2, therefore, m=4 and n=2, and therefore, Q=12, P1=10, and P2=14.

Through this configuration, compared to the rotating machine including the plurality of fixation parts, the rotating machine including the single fixation part may reduce the number of end-windings, and securing larger sizes of the iron core of the at least one fixation part and the permanent magnet, thereby increasing the output and efficiency of the electric motor or the generator, and miniaturizing the rotating machine.

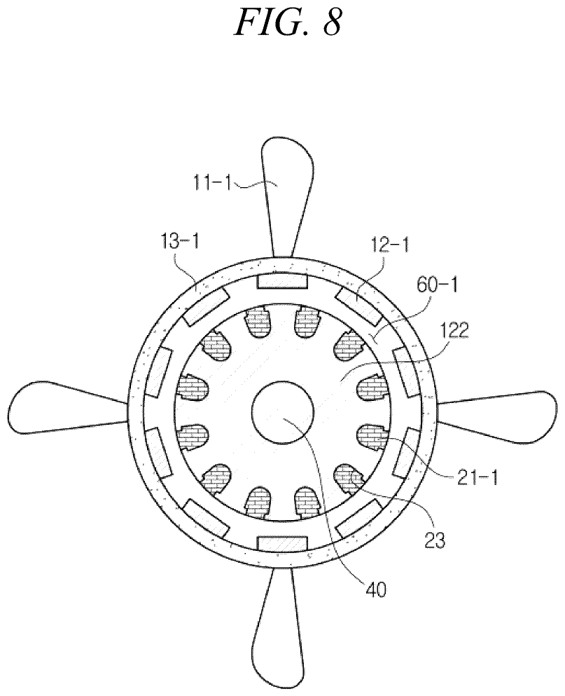

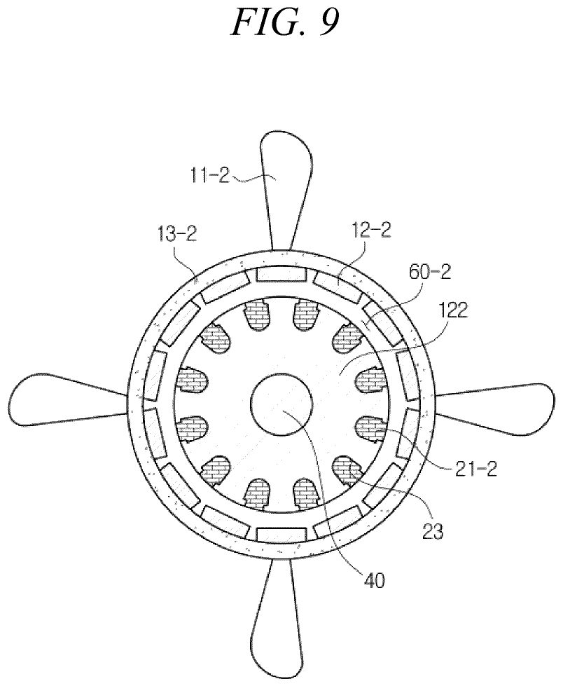

FIG. 8 is a cross-sectional view taken along line D-D of FIG. 7, and FIG. 9 is a cross-sectional view taken along line E-E of FIG. 7.

Referring to FIG. 8, the first rotation module propeller 11-1 may be disposed outside the rotating machine. Toward the inside of the rotating machine, the following may be sequentially disposed: the first rotation module propeller 13-1, the first rotation module-permanent magnet 12-1 installed on the inner peripheral surface of the first rotation module support 13-1, the first rotation module-permanent magnet 12-1 installed on the inner peripheral surface of the first rotation module support 13-1, the first motor air gap 60-1, the fixation module-motor slot 23 which is included in the at least one fixation part and around which the fixation module-motor winding 21-1 of the at least one fixation part may be wound, the single fixation module-motor iron core 122, and the fixed shaft 40. Here, the number Q of the fixation module-motor slots 23 in the at least one fixation part may be 12, and the number P1 of the first rotation module-permanent magnets 12-1 may be 10.

Referring to FIG. 9, the second rotation module propeller 11-2 may be disposed outside the rotating machine. Toward the inside of the rotating machine, the following may be sequentially disposed: the second rotation module support 13-2, the second rotation module-permanent magnet 12-2 installed on the inner peripheral surface of the second rotation module support 13-2, the second motor air gap 60-2, the fixation module-motor slot 23 which is included in the at least one fixation part and around which the second fixation module-motor winding 21-2 of the at least one fixation part may be wound, the single fixation module-motor iron core 122, and the fixed shaft 40. Here, the number Q of the fixation module-motor slots 23 in the at least one fixation part may be 12, and the number P2 of the second rotation module-permanent magnets 12-2 may be 14.

However, the fixation module-motor slot 23 of the at least one fixation part, the first rotation module-permanent magnet 12-1, and the second rotation module-permanent magnet 12-2, in the present disclosure, are not limited to the numbers or the placement structures according to the fourth embodiment, and may include the number of fixation module-motor slots 23 of all the at least one fixation parts, the number of first rotation module-permanent magnets 12-1, and the number of second rotation module-permanent magnets 12-2, enabling proper operations of the permanent magnet and the at least one fixation part, where the two counter-rotating permanent magnets share the winding of the single fixation part.

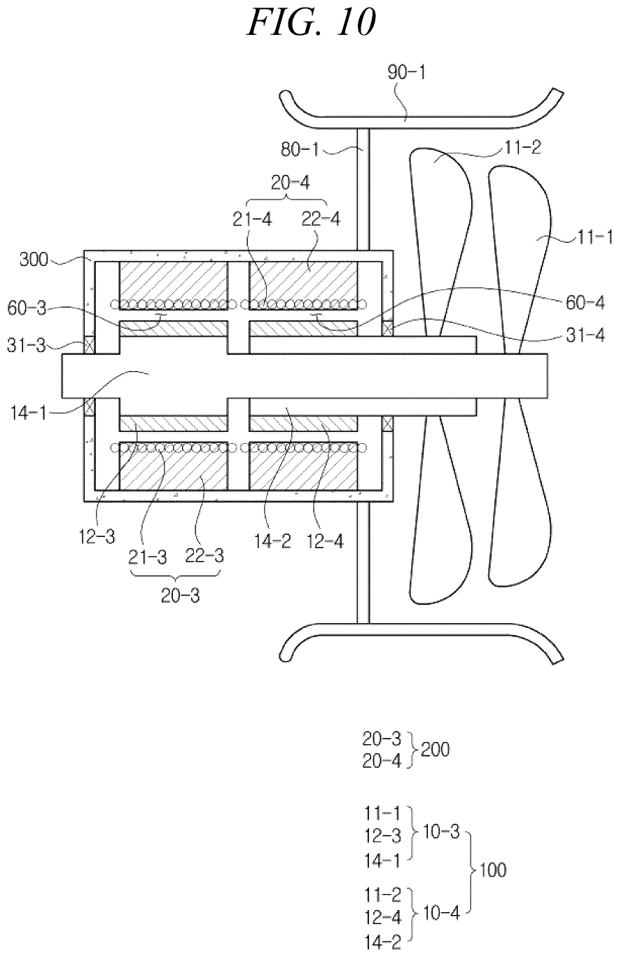

FIG. 10 is a cross-sectional view showing a rotating machine including an inner rotor according to a fifth embodiment of the present disclosure.

Referring to FIG. 10, the rotating machine according to the fifth embodiment may include a cylindrical enclosure 300 of an inner-rotor motor (or internal rotation-type motor), a fixation module 200 of the inner-rotor motor that includes a fixation part coupled to an inner peripheral surface of the cylindrical enclosure 300 of the inner-rotor motor, a rotation module 100 of the inner-rotor motor that rotates at the center of the cylindrical enclosure 300 of the inner-rotor motor, and a fluid duct support 80-1 of the inner-rotor motor or a fluid duct 90-1 of the inner-rotor motor, disposed outside the cylindrical enclosure 300 of the inner-rotor motor.

The enclosure 300 of the inner-rotor motor may have the cylindrical shape and have the at least one fixation part coupled to its inner peripheral surface, and the rotation module 100 of the inner-rotor motor may be disposed at the center of the enclosure 300 of the inner-rotor motor and rotatably supported by the enclosure 300.

The rotation module 100 of the inner-rotor motor may include a first rotation module 10-3 of the inner-rotor motor and a second rotation module 10-4 of the inner-rotor motor, and the first rotation module 10-3 of the inner-rotor motor and the second rotation module 10-4 of the inner-rotor motor may be disposed coaxially with a central axis of the enclosure 300 of the inner-rotor motor.

The first rotation module 10-3 of the inner-rotor motor may include a rotating first rotation module shaft 14-1 of the inner-rotor motor, and the second rotation module 10-4 of the inner-rotor motor may include a rotating second rotation module shaft 14-2 of the inner-rotor motor while surrounding an outer peripheral surface of the first rotation module shaft of the inner-rotor motor 14-1.

The first rotation module propeller 11-1 may be installed at an end of the first rotation module shaft 14-1 of the inner-rotor motor, and the second rotation module propeller 11-2 may be installed at an end of the second rotation module shaft 14-2 of the inner-rotor motor. Here, the first rotation module propeller 11-1 and the second rotation module propeller 11-2 may have different blade directions, thus rotating the first rotation module 10-3 of the inner-rotor motor and the second rotation module 10-4 of the inner-rotor motor in contra-directions.

The rotating machine including the contra-rotating propeller (CRP) where two propellers rotating in opposite directions are disposed on the same axis may improve the efficiency of the rotor or the generator by recovering the rotational energy lost from the front propeller to the rear propeller.

A first rotation module-permanent magnet 12-3 of the inner-rotor motor may be installed on a portion of the outer peripheral surface of the first rotation module shaft 14-1 of the inner-rotor motor, and a second rotation module-permanent magnet 12-4 of the inner-rotor motor may be installed on a portion of an outer peripheral surface of the second rotation module shaft 14-2 of the inner-rotor motor. Therefore, between the at least one fixation parts around each of which the winding is wound, the first rotation module-permanent magnet 12-3 of the inner-rotor motor may be an inner rotating machine (or inner rotor) rotating while being spaced apart therefrom by a first gap 60-3 of the inner-rotor motor, and the second rotation module-permanent magnet 12-4 of the inner-rotor motor may be an inner rotating machine (or inner rotor) rotating while being spaced apart therefrom by a second gap 60-4 of the inner-rotor motor.

The fluid duct support 80-1 of the inner-rotor motor may have one end connected to the enclosure 300 of the inner-rotor motor and the other end extending outward.

The fluid duct 90-1 of the inner-rotor motor may be fixed to the fluid duct support 80-1 of the inner-rotor motor and guide the fluid flowing outside the first rotation module propeller 11-1 or the second rotation module propeller 11-2 to the first rotation module propeller 11-1 or the second rotation module propeller 11-2. In detail, the fluid duct 90-1 of the inner-rotor motor may be long in the horizontal direction to be parallel to the rotation module shaft 14-1 or 14-2 of the inner-rotor motor, and include a main body fixed to one end of the fluid duct support 80-1 of the inner-rotor motor and wings bent outward at each of two ends of the main body. The wing may have the end bent outward to thus more efficiently guide the fluid flowing outside the first rotation module propeller 11-1 or the second rotation module propeller 11-2 to the first rotation module propeller 11-1 or the second rotation module propeller 11-2.

In addition, the first rotation module propeller 11-1 or the second rotation module propeller 11-2 according to the fifth embodiment may be disposed on one side based on the enclosure 300 of the inner-rotor motor, the wing of the fluid duct 90-1 of the inner-rotor motor may extend in a direction in which the first rotation module propeller 11-1 or the second rotation module propeller 11-2 is disposed, the fluid duct support 80-1 of the inner-rotor motor may be connected to one side of the main body rather than its center, and the wing may have its end only bent outward in the direction in which the first rotation module propeller 11-1 or the second rotation module propeller 11-2 is disposed.

In this way, the fluid duct 90-1 of the inner-rotor motor that is disposed outside the rotating machine may allow the fluid to flow compressively to the first rotation module propeller 11-1 or the second rotation module propeller 11-2 to thus improve the output magnitude and efficiency of the rotating machine, and protect the first rotation module propeller 11-1 or the second rotation module propeller 11-2 that protrudes outward from the external impact.

However, the fluid duct 90-1 of the inner-rotor motor in the present disclosure is not limited to its shape or connection structure according to the fifth embodiment, and may include any shape or connection structure disposed outside the propeller and inducing the flow of the fluid to the propeller of the rotating machine.

A rotation module-shaft bearing 31-3 of the inner-rotor motor may be disposed between the first rotation module shaft 14-1 and enclosure 300 of the inner-rotor motor, and a rotation module-shaft bearing 31-4 of the inner-rotor motor may be disposed between the second rotation module shaft 14-2 and enclosure 300 of the inner-rotor motor. Therefore, the first rotation module shaft 14-1 of the inner-rotor motor and the second rotation module 10-4 of the inner-rotor motor may rotate in the fixed enclosure 300 of the inner-rotor motor.

Although not shown in FIG. 10, the enclosure 300 of the inner-rotor motor may include the cooling hole 50 to dissipate heat occurring therein. The cooling hole 50 may pass through at least one of the front, rear, or sides of the enclosure 300 of the inner-rotor motor to thus allow a fluid outside the enclosure 300 of the inner-rotor motor to flow into the enclosure 300 of the inner-rotor motor or a fluid inside the enclosure 300 of the inner-rotor motor to exit to the outside.

In a case where the plurality of fixation parts are provided, the at least one fixation parts may include a first fixation module fixation part 20-3 of the inner-rotor motor that faces the first rotation module-permanent magnet 12-3 of the inner-rotor motor, and a second fixation module fixation part 20-4 of the inner-rotor motor that faces the second rotation module-permanent magnet 12-4 of the inner-rotor motor. The first fixation module fixation part 20-3 of the inner-rotor motor and the second fixation module fixation part 20-4 of the inner-rotor motor may be spaced apart from each other.

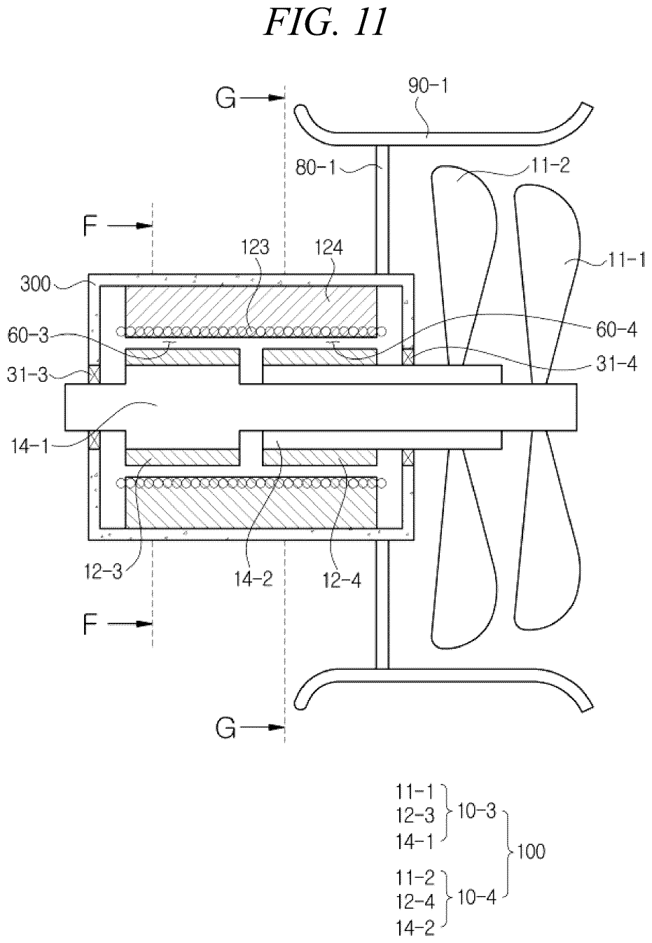

FIG. 11 is a cross-sectional view showing a rotating machine including an inner rotor according to a sixth embodiment of the present disclosure.

Referring to FIG. 11, the rotating machine according to the sixth embodiment has a difference in disposing the single fixation part compared to the fifth embodiment. In detail, the single fixation part may be disposed while having at least a portion facing the first rotation module-permanent magnet 12-3 of the inner-rotor motor, and at least another portion facing the second rotation module-permanent magnet 12-4 of the inner-rotor motor.

Like the difference between the third embodiment disclosing the plurality of fixation parts and the fourth embodiment disclosing the single fixation part, compared to the fifth embodiment disclosing the plurality of fixation parts, the sixth embodiment discloses the single fixation part, thereby reducing the number of end-windings to two end-windings, and securing larger sizes of the iron core of the at least one fixation part and the permanent magnet in the rotating machine of the same volume.

However, the electric motor and the generator, where the two counter-rotating permanent magnets share the winding of the single fixation part (or single stator), may require a special combination of the numbers of the permanent magnets in the at least one fixation part and the numbers of the fixation module-motor slots.

Accordingly, in the sixth embodiment of the present disclosure, Q, P1, and P2 may satisfy Q=3·m, P1=3·m−n, P2=3·m+n (where, m−a, n=a−2·b+2, a and b are natural numbers, and m·n>0). For example, a=4 and b=2, therefore, m=4 and n=2, and therefore, Q=12, P1=10, and P2=14.

Through this configuration, compared to the rotating machine including the plurality of fixation parts, the rotating machine including the single fixation part may reduce the number of end-windings, and securing larger sizes of the iron core of the at least one fixation part and the permanent magnet, thereby increasing the output and efficiency of the electric motor or the generator, and miniaturizing the rotating machine.

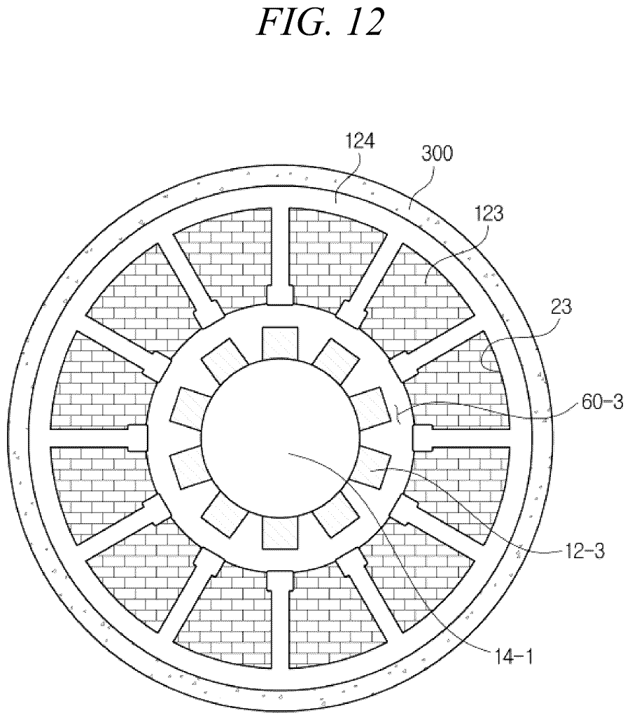

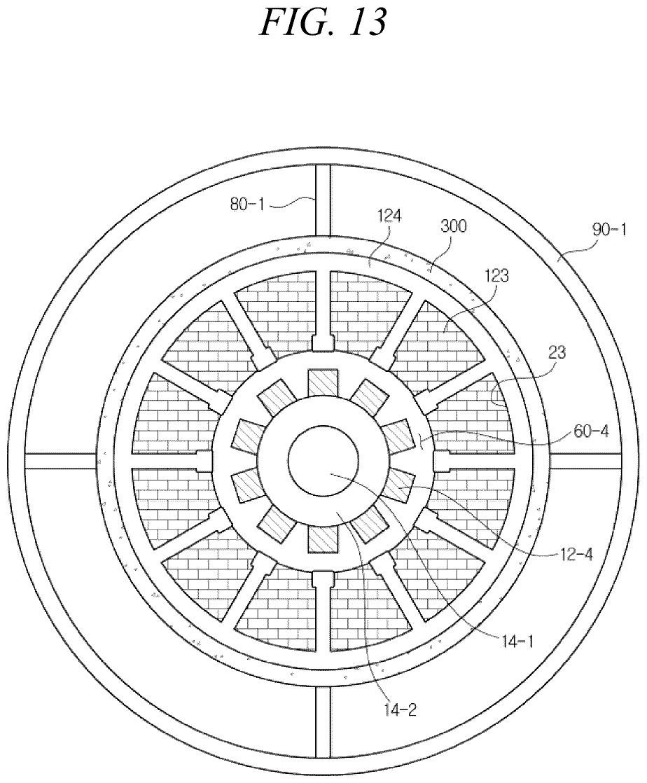

FIG. 12 is a cross-sectional view taken along line F-F of FIG. 11, and FIG. 13 is a cross-sectional view taken along line G-G of FIG. 11.

Referring to FIG. 12, the enclosure 300 of the inner-rotor motor may be disposed outside the rotating machine. Toward the inside of the rotating machine, the following may be sequentially disposed: a single fixation module-motor iron core 124 of the inner-rotor motor, the fixation module-motor slot 23 around which the single fixation module-motor winding 123 of the inner-rotor motor may be wound, a single fixation module-motor winding 123 of the inner-rotor motor, the first gap 60-3 of the inner-rotor motor, the first rotation module-permanent magnet 12-3 of the inner-rotor motor, and the first rotation module shaft 14-1 of the inner-rotor motor. Here, the number Q of the slots 23 in the at least one fixation part may be 12, and the number P1 of the first rotation module-permanent magnet 12-3 of the inner-rotor motor may be 10.

Referring to FIG. 13, the fluid duct 90-1 of the inner-rotor motor and the fluid duct support 80-1 of the inner-rotor motor may be disposed outside the rotating machine. Toward the inside of the rotating machine, the following may be sequentially disposed: the enclosure 300 of the inner-rotor motor, the single fixation module-motor iron core 124 of the inner-rotor motor, the single fixation module-motor winding 123 of the inner-rotor motor, the fixation module-motor slot 23 around which the single fixation module-motor winding 123 of the inner-rotor motor may be wound, the single fixation module-motor winding 123 of the inner-rotor motor, the second gap 60-4 of the inner-rotor motor, the second rotation module-permanent magnet 12-4 of the inner-rotor motor, the second rotation module shaft 14-2 of the inner-rotor motor, and the first rotation module shaft 14-1 of the inner-rotor motor. Here, the number Q of the slots in the at least one fixation part may be 12, and the number P1 of the second rotation module-permanent magnet 12-4 of the inner-rotor motor may be 14.

However, the fixation module-motor slot 23 of the at least one fixation part, the first rotation module-permanent magnet 12-3 of the inner-rotor motor, and the second rotation module-permanent magnet 12-4 of the inner-rotor motor, in the present disclosure, are not limited to the numbers or the placement structures according to the sixth embodiment, and may include the number of fixation module-motor slots 23 of all the fixation parts, the number of first rotation module-permanent magnets 12-3 of the inner-rotor motor, and the number of second rotation module-permanent magnets 12-4 of the inner-rotor motor, enabling proper operations of the permanent magnet and the at least one fixation part, where the two counter-rotating permanent magnets share the winding of the single fixation part.

According to the various embodiments of the present disclosure, the rotating machine having a contra-rotating propeller may include the outer rotor or the inner rotor, include one fixation part for the two counter-rotating permanent magnets, or include the fluid duct 90 or fluid duct 90-1 of the inner-rotor motor to thus improve the maximum output and efficiency of the rotating machine, and minimize the volume of the device, thereby implementing the miniaturization of the electric motor or the generator. In addition, the fluid duct 90 or fluid duct 90-1 of the inner-rotor motor may protect the specific components of the rotating machine from the external impact, and allow the external fluid to communicate with the internal fluid by including the cooling hole 50 to thus enable the effective heat dissipation of the rotating machine, thereby increasing the versatility and improving marketability of the rotating machine having a contra-rotating propeller.

Although the embodiment of the present disclosure has been described, it is to be understood that the present disclosure is not limited to the disclosed embodiment. Various modifications may be made within the scopes of the claims, description, and accompanying drawings of the present disclosure, which also fall within the scope of the present disclosure.

1. A rotating machine comprising:
a fixed shaft;
a fixation module having at least one fixation part coupled to an outer peripheral surface of the fixed shaft; and
a rotation module rotatably supported by the fixed shaft,
wherein the rotation module includes
a first rotation module including a first rotation module support having a space accommodating a portion of the at least one fixation part, a first rotation module-permanent magnet installed on an inner peripheral surface of the first rotation module support, and a first rotation module propeller installed on an outer peripheral surface of the first rotation module support, and
a second rotation module including a second rotation module support having a space accommodating another portion of the at least one fixation part, a second rotation module-permanent magnet installed on an inner peripheral surface of the second rotation module support, and a second rotation module propeller installed on an outer peripheral surface of the second rotation module support, and
the first rotation module and the second rotation module are disposed to be parallel to each other in an axial direction and rotate in contra-directions.

2. The rotating machine of claim 1, wherein the at least one fixation part includes a fixation module-motor winding and a fixation module-motor iron core around which the fixation module-motor winding is wound, and
the at least one fixation part provided as a single unit, is disposed while having at least a portion facing the first rotation module-permanent magnet and at least another portion facing the second rotation module-permanent magnet.

3. The rotating machine of claim 2, wherein the at least one fixation part includes a fixation module-motor slot around which the fixation module-motor winding is wound, and
Q=3·m, P1=3·m−n, P2=3·m+n (where, m=a, n=a−2·b+2, a and b are natural numbers, and m·n>0) when Q indicates the number of fixation module-motor slots, P1 indicates the number of first rotation module-permanent magnets, and P2 indicates the number of second rotation module-permanent magnets.

4. The rotating machine of claim 3, wherein a=4 and b=2,
therefore, m=4 and n=2, and
therefore, Q=12, P1=10, and P2=14.

5. The rotating machine of claim 1, wherein the at least one fixation part includes a fixation module-motor winding and a fixation module-motor iron core around which the fixation module-motor winding is wound, and
wherein at least two of the at least one fixation part are disposed while including a first fixation module-motor fixation part facing the first rotation module-permanent magnet, and a second fixation module-motor fixation part facing the second rotation module-permanent magnet.

6. The rotating machine of claim 1, wherein the fixation module includes a motor support having one end connected to the fixed shaft and the other end extending outward in the other direction to support the first rotation module support and the second rotation module support.

7. The rotating machine of claim 6, wherein the fixation module includes a fluid duct support having one end connected to the motor support and the other end extending outward.

8. The rotating machine of claim 7, wherein the fixation module includes a fluid duct fixed to the fluid duct support and guiding a fluid flowing outside the first rotation module propeller or the second rotation module propeller to the first rotation module propeller or the second rotation module propeller.

9. The rotating machine of claim 1, wherein the first rotation module and the second rotation module are spaced apart from each other.

10. The rotating machine of claim 1, wherein at least one of the at least one fixation part, the first rotation module-permanent magnet, and the second rotation module-permanent magnet is treated with a waterproof coating.

11. The rotating machine of claim 1, further comprising a rotation module bearing disposed between the rotation module and the fixation module for the rotation module to be rotatable above the fixation module.

12. The rotating machine of claim 11, wherein the rotation module bearing includes
a first rotation module shaft bearing disposed between the fixed shaft and the first rotation module support, and
a second rotation module shaft bearing disposed between the fixed shaft and the second rotation module support.

13. The rotating machine of claim 11, wherein the fixation module includes a motor support having one end connected to the fixed shaft and the other end extending outward to support the first rotation module support and the second rotation module support, and
the rotation module bearing includes
a first motor support bearing disposed between the motor support and the first rotation module support, and
a second motor support bearing disposed between the motor support and the second rotation module support.

14. The rotating machine of claim 1, further comprising a cooling hole disposed in the fixation module or the rotation module, and allowing a fluid flowing outside the rotation module and a fluid flowing inside the rotation module to communicate with each other.

15. A rotating machine comprising:
a cylindrical enclosure of an inner-rotor motor;
a fixation module of the inner-rotor motor that includes at least one fixation part coupled to an inner peripheral surface of the enclosure of the inner-rotor motor; and
a rotation module of the inner-rotor motor that is disposed at a center of the enclosure of the inner-rotor motor and rotatably supported by the enclosure of the inner-rotor motor,
wherein the rotation module of the inner-rotor motor includes a first rotation module of the inner-rotor motor that includes a rotating first rotation module shaft of the inner-rotor motor, a first rotation module-permanent magnet of the inner-rotor motor that is installed on a portion of an outer peripheral surface of the first rotation module shaft of the inner-rotor motor and faces a portion of the at least one fixation part, and a first rotation module propeller installed at an end of the first rotation module shaft of the inner-rotor motor, and
a second rotation module of the inner-rotor motor that includes a second rotation module shaft of the inner-rotor motor that rotates while surrounding the outer peripheral surface of the first rotation module shaft of the inner-rotor motor, a second rotation module-permanent magnet of the inner-rotor motor that is installed on a portion of an outer peripheral surface of the second rotation module shaft of the inner-rotor motor and faces another portion of the at least one fixation part, and a second rotation module propeller installed at an end of the second rotation module shaft of the inner-rotor motor,
the first rotation module of the inner-rotor motor and the second rotation module of the inner-rotor motor are disposed on the same axis and rotate in contra-directions to each other, and
the fixation module of the inner-rotor motor includes
a fluid duct support of the inner-rotor motor that has one end connected to the enclosure of the inner-rotor motor and the other end extending outward, and
a fluid duct of the inner-rotor motor that is fixed to the fluid duct support of the inner-rotor motor and guides a fluid flowing outside the first rotation module propeller or the second rotation module propeller to the first rotation module propeller or the second rotation module propeller.

16. The rotating machine of claim 15, wherein the at least one fixation part includes a fixation module-motor winding of the inner-rotor motor and a fixation module-motor iron core of the inner-rotor motor, around which the fixation module-motor winding of the inner-rotor motor is wound,
the at least one fixation part includes a fixation module-motor slot around which the fixation module-motor winding of the inner-rotor motor is wound, and
Q=3·m, P1=3·m−n, P2=3·m+n (where, m=a, n=a−2·b+2, a and b are natural numbers, and m·n>0) when Q indicates the number of fixation module-motor slots, P1 indicates the number of first rotation module-permanent magnets, and P2 indicates the number of second rotation module-permanent magnets.

17. The rotating machine of claim 16, wherein a=4 and b=2,
therefore, m=4 and n=2, and
therefore, Q=12, P1=10, and P2=14.

18. The rotating machine of claim 15, wherein at least two of the at least one fixation part are disposed while including a first fixation module-motor fixation part of the inner-rotor motor that faces the first rotation module-permanent magnet of the inner-rotor motor, and a second fixation module-motor fixation part of the inner-rotor motor that faces the second rotation module-permanent magnet of the inner-rotor motor.

19. The rotating machine of claim 15, wherein the at least one fixation part is disposed while having at least a portion facing the first rotation module-permanent magnet of the inner-rotor motor and at least another portion facing the second rotation module-permanent magnet of the inner-rotor motor.
